(19) United States
(12) Patent Application Publication
(10) Pub. No.: US 2007/0274454 A1
(43) Pub. Date: Nov. 29, 2007

(54) X-RAY RADIATOR WITH A THERMIONIC PHOTOCATHODE

(76) Inventors: Joerg Freudenberger, Eckental (DE); Sven Fritzler, Erlangen (DE); Manfred Fuchs, Nurnberg (DE); Detlef Mattern, Erlangen (DE); Peter Roehrer, Uttenreuth (DE); Peter Schardt, Hochstadt A.D. Aisch (DE)

Correspondence Address: SCHIFF HARDIN, LLP;PATENT DEPARTMENT, 6600 SEARS TOWER, CHICAGO, IL, 60606-6473, US

(21) Appl. No.: 11/752,585

(22) Filed: May 23, 2007

(30) Foreign Application Priority Data
May 24, 2006 (DE) 10 2006 024 437.0

(51) Int. Cl. H01J 35/06

(52) U.S. Cl. 378/136

(57) ABSTRACT

An x-ray radiator has an anode that emits x-rays when struck by electrons, a cathode that thermionically emits electrons upon irradiation thereof by a laser beam, a voltage source for application of a high voltage between the anode and the cathode for acceleration of the emitted electrons towards the anode to form an electron beam. A surface of the cathode that can be irradiated by the laser beam is at least partially roughened and/or doped and/or is formed of an intermetallic compound or vitreous carbon.

### BACKGROUND OF THE INVENTION

1. Field of the Invention

The present invention concerns an x-ray radiator with a cathode and an anode, of the type wherein the cathode has a surface that emits electrons upon laser irradiation of the surface.

2. Description of the Prior Art

High-capacity x-ray radiators typically have an anode that is mounted to rotate in order to ensure a high thermal loading capability of the anode during generation of x-rays with high radiation power.

DE 87 13 042 U1 describes an x-ray tube with an evacuated housing (the housing is evacuated in order to be mounted such that it can be rotated around a rotation axis) in which a cathode and an anode are arranged. The cathode and the anode are connected in a fixed manner with the housing. The x-ray tube has drive means for rotation of the housing around the rotation axis. A deflection system that is stationary relative to the housing deflects an electron beam proceeding from the cathode to the anode such that it strikes the anode on an annular impact surface, the axis of this annular impact surface corresponding to the rotation axis that runs through the cathode. Since the anode is connected in a heat-conductive manner with the wall of the housing, heat dissipation from the anode to the outer surface of the housing is ensured. An effective cooling is possible via a coolant that is admitted to the housing.

In this arrangement a relatively long electron flight path is present due to the axis-proximal position of the cathode and the axis-remote position of the impact surface of the anode. This creates problems in the focusing of the electron beam. Among other things, a problem occurs in the generation of soft x-ray radiation given which a comparably low voltage is applied between cathode and anode. Due to the lower kinetic energy of the electrons, a higher defocusing of the electron beam occurs, dependent on the space charge limitation. The use of such an x-ray tube is possible only in a limited manner for specific applications (such as, for example, mammography).

U.S. Pat. No. 4,821,305 discloses an x-ray tube is described in which both the anode and the cathode are arranged axially symmetrically in a vacuum housing that can be rotated as a whole around an axis. The cathode is thus mounted so it can rotate and has an axially symmetrical surface made of a material that photoelectrically emits electrons upon exposure to light of appropriate power (photoelectrons). The electron emission is triggered by a spatially stationary light beam that is focused from the outside of the vacuum housing through a transparent window onto the cathode.

The practical feasibility of this concept, however, appears to be questionable due to the quantum efficiency of available photo-cathodes and the light power that is required. Given use of high light power, the cooling of the photo-cathode requires a considerable expenditure due to its rather low heat resistance. In view of the vacuum conditions that exist in x-ray tubes, the surface of the photo-cathode is additionally subjected to oxidation processes, which limits the durability of such an x-ray tube.

In U.S. Pat. No. 5,768,337, a photomultiplier is interposed between a photo-cathode and the anode in a vacuum housing in which the photo-cathode and the anode are arranged. Thus, a lower optical power is necessary for generation of x-ray radiation. The longer electron flight path with repeated deflection of the electron beam between the dynodes, however, requires a high expenditure for focusing the beam.

An x-ray scanner (in particular a computed tomography scanner) is known from EP 0 147 009 B1. X-rays are thereby generated by an electron beam striking an anode. Among other things, the possibility is mentioned to generate the electron beam by thermionically-emitted electrons by heating the cathode surface with a light beam. The surface of the cathode should be capable of being heated and cooled quickly in the disclosed embodiment of the cathode with a substrate layer made of a material with high heat conductivity, but this appears to be problematic with regard to the light power that is required.

U.S. Pat. No. 6,556,651 describes a system for generation of therapeutic x-rays. Among other things, the possibility is generally mentioned that the electron beam required for the generation of x-ray radiation is emitted by a thermionic cathode heated by a laser.

Solid metallic tungsten is typical as a cathode material.

### SUMMARY OF THE INVENTION

An object of the present invention is to provide an x-ray radiator suitable for use in medical radiology, with a laser-activated cathode with which a sufficient x-ray power can be generated with relatively low laser power and with which a simple and efficient cooling of the system enables a rapid reuse capability.

This object is achieved in accordance with the invention an x-ray radiator having at least one anode that emits x-rays when struck by electrons, a cathode that thermionically emits electrons upon irradiation by a laser beam, and a voltage source that applies a voltage between the anode and the cathode for acceleration of the emitted electrons toward the anode to form an electron beam. Any of the following can be used alternatively or in suitable combinations as to form at least a portion of the surface of the cathode:

(1) surface-roughened and/or porous material, in particular at least one material from the group consisting of tungsten, rhenium, molybdenum, thorium and tantalum;, for example, essentially pure W, Rh, Mo, Th and Ta or a mixture thereof; and/or

(2) doped material, in particular with dopants in the form of oxides of the rare earths (Sc, Y, La and the lanthanides and/or actinides such as thorium) or their mischmetals; and/or

(3) an intermetallic compound; and/or

(4) vitreous carbon.

The use of a surface-roughened cathode surface causes incident laser light to be repeatedly scattered on the surface so as to be more strongly absorbed. The reflectivity is thereby reduced and the injection efficiency of the employed laser power is increased. The cathode surface is advantageously roughened by a sintering process. Given use of a likewise sintered cathode support (substrate), advantageously as a common, one-piece component, the further advantage is achieved that depending on porosity, the specific heat capacity and the density can be reduced (by the sintering structure) to between, for example, 40% and 80% of that of pure material; even less laser power is required in order to achieve the necessary emission laser temperature at the laser focus, but the heat conductivity is still sufficient to suitably cool the cathode. Porosity, for example for sintered tungsten, advantageously lie between 20% and 60%, preferably between 35% and 45%, in particular at approximately or exactly 40%. A porosity range can be set somewhat specifically in sintering, for example by the sinter duration, the sinter pressure, the density of the base body and so forth. Those skilled in the art can achieve a compromise between reduced heat conductivity and decreasing durability of the work piece. The object is also achieved by the specified materials, which exhibit a suitably porosity without exhibiting a significant roughness (or vice versa). From the viewpoint of a high effectiveness a combination of both properties is particularly advantageous. The use of tungsten-rhenium as a cathode material is also advantageous, possibly with admixtures of thorium.

The use of a doped material in the cathode surface achieves a decrease in the electron work function. The operating temperature of the electron emitter thus can be distinctly lowered, whereby (i) less laser power is required and (ii) the vapor pressure of the cathode is even lower, such that high voltage field gradients can be applied. The doped cathode base material preferably has at least one material from the group comprising of tungsten, molybdenum and tantalum; thus, for example, essentially pure W, Mo and Ta or a mixture thereof. In particular, use of tungsten as a base material (matrix material) with La₂O₃ and/or CeO as doping agents is advantageous. The doping degree advantageously lies between 0.5% and 20%. For example, for pure thorium as a doping agent a material proportion around 1% is advantageous. The doping, possibly together with a surface roughening, preferably lowers the electron work function to below 3.5 eV, especially to 1.5 eV to 3.5 eV.

A cathode surface material that is both roughened and doped is particularly advantageous.

The vitreous carbon likewise advantageously lowers the electron work function to below 3 eV, in particular between 1.8 eV and 2.8 eV.

The suitability of vitreous carbon has surprisingly emerged through experimentation. This is not to be expected because typically pure carbon exhibits a high electron escape energy of approximately 5 eV, which means that non-vitreous carbon as a cathode must typically be operated at very high temperatures of 3000 K. At such temperatures, the vapor pressure is too poor to allow typical carbon to be used in a sealed x-ray tube.

Vitreous carbon advantageously exhibits one or more of the following properties:
an electron work function between 1.8 eV and 2.8 eV, reflectivities of 10% to 50% in the spectral range from 800 to 1200 nm;
a density of 900 to 1700 kg/m³;
a specific heat capacity of 1 to 1.3 J/(gK) at 200° C., of 1.6 to 2.0 J/(gK) at 700° C. and of 1.9 to 2.3 J/(gK) at 1400° C.
a heat conductivity of 6.0 to 7.2 W/(mK) at 20° C., of 9.3 to 11.5 W/(mK) at 750° C. and of 10.0 to 12.5 W/(mK) at 1200° C.

These properties can also be achieved by intermetallic compounds. Such compounds are known for the fact that they can be brought to emission at low temperatures of a few hundred Kelvin. They thus also fulfill the requirement with regard to the vapor pressure.

The electron work function can likewise be decreased by the use of the intermetallic compounds.

An intermetallic compound is advantageously used which the electron work function lies between 2.2 eV and 2.6 eV at 1300 K and between 2.5 eV and 2.7 eV at 2100 K. Mixture ratios are advantageously in the range of 1:1, 1:2, 1:3, 1:4, 1:5. The embodiment of the intermetallic compound as an alloy in a stoichiometric ratio is particularly advantageous.

Preferred intermetallic compounds are mischmetals composed of one or more platinum metals (for example Ru, Os, Rh, Ir; Pt, Pd) and one or more rare earths. Of the rare earths, the lanthanides lanthanum, cerium and samarium can be used particularly advantageously, in particular IrCe, especially in a mixture ratio of 1:1 to 1:2.

The material of the cathode surface can be a thin film or thick film produced on a cathode substrate or can be the surface of a one-piece cathode element wherein no differentiation exists between the material of the surface and that of the substrates.

All inventive materials listed above achieve the object and have the effect that a lower laser power is required for a temperature increase, a good vacuum stability of an x-ray radiator can be achieved and the cathode remains easy to handle mechanically.

An embodiment of the x-ray radiator furthermore includes a vacuum housing that can be rotated around an axis, an insulator that separates the cathode from the anode, a drive for rotation of the vacuum housing around its axis, an arrangement for cooling components of the x-ray radiator, and arrangement that directs the laser beam from a stationary source, that is arranged outside of the vacuum housing, onto a spatially stationary laser focal spot on the cathode and that focuses the laser beam.

Diode lasers or solid-state lasers can be used as the laser source.

### DESCRIPTION OF THE DRAWINGS

FIG. 1 schematically illustrates a vacuum housing or an-ray radiator in accordance with the invention

FIG. 2 is a longitudinal section through a portion of a further embodiment of the vacuum housing.

### DESCRIPTION OF THE PREFERRED EMBODIMENTS

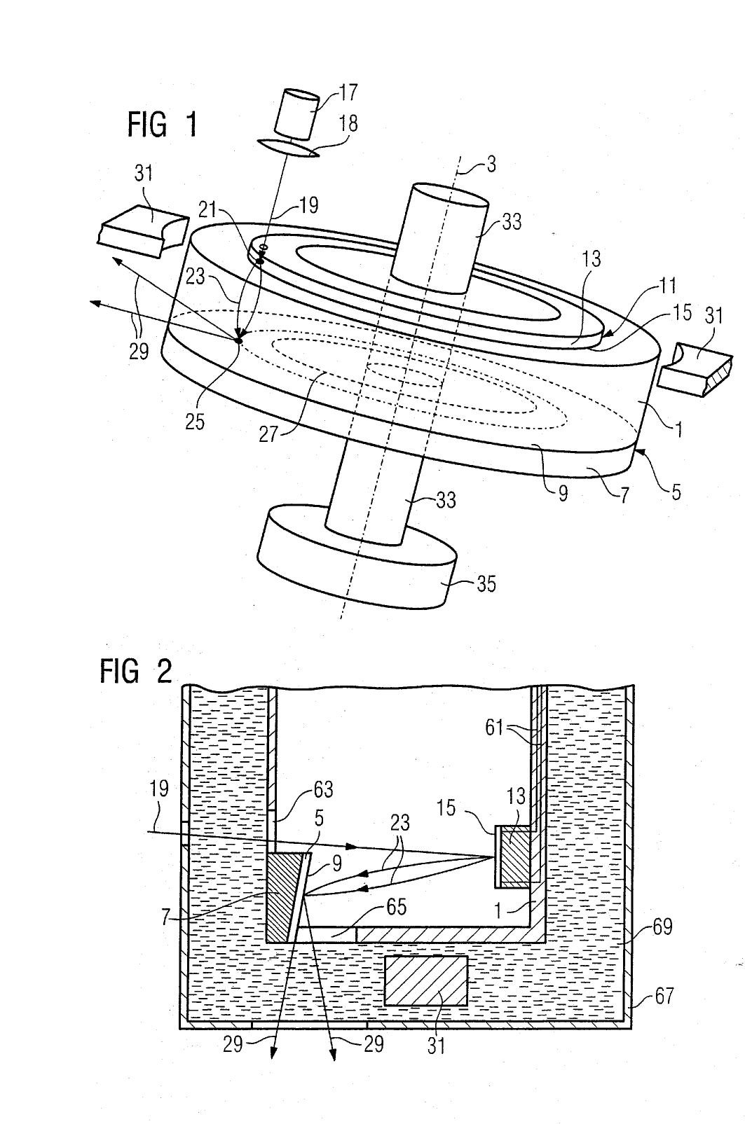

A three-dimensional representation of a vacuum housing 1 is shown in FIG. 1. The vacuum housing 1 is fashioned as a cylinder (having a cylinder jacket formed of an insulating material) and the cylinder is mounted in a rotationally symmetrical manner on an axis 3. An anode 5 forms a base of the cylinder. The anode 5 has a support layer 7 and an annularly-fashioned surface 9 from which x-rays 29 are emitted. An annularly-fashioned cathode 11 is located in the opposite base of the vacuum housing 1 (cylinder). The cathode 11 has a support layer 13 that is part of the exterior of the vacuum housing 1 and a surface 15 that facing the interior of the vacuum housing 1.

The anode 5 and cathode 11 shown in FIG. 1 are fashioned axially symmetrically, such that the electron beam or the laser beam always strikes the surface of the anode 5, or the cathode 11 during the rotation. However, it can also be advantageous to fashion the anode 5 and the cathode 11 (in particular their support layers 7, 13) such that they exhibit only one axis of symmetry. This means a segmented design of the cathode 11 or the anode 5, such that a rotation of the cathode 11 or of the anode 5 by a whole-number divisor of 360° leads to an identical image of the cathode 11 or of the anode 5; materials of higher mechanical stability that are arranged as spokes in the cathode 11 or in the anode 5 can support segments of materials with high emission efficiency.

The surface 15 of the cathode 11 is formed of a material having a low vapor pressure and a high melting point (such as, for example, tungsten, which is typically used in x-ray cathodes). The carrier layer 13 is optimized with regard to its heat capacity, its heat conductivity and its density such that the temperature of the surface 15 is kept near the temperature required for the thermionic emission of electrons. A lower power of the laser beam 19 is thereby required. In one possible embodiment the support layer 13 is made of the same material as the surface 15, but the material in the support layer 13 is not in a solid, uniform form but rather in a sintered or porous structure. The density, the heat capacitor and/or the heat conductivity of the support layer 13 are thereby reduced in comparison to the surface 15. The temperature of the surface 15 can thereby be kept near to the emission temperature for electrons.

The laser beam is asymmetrically shaped (not shown), so an asymmetrical laser focal spot with different laser power can be generated within the laser focal spot. Laser power can thereby be saved; while approximately equally steeply rising and falling temperature gradients at the edges can be generated at the laser focal spot at the entrance and exit points of the cathode, which leads to an efficient electron emission at a constant level over the laser focal spot.

A laser beam 19 is directed from a spatially stationary light source 17 onto the cathode 11. The light source 17 is typically designed as a diode laser or as a solid-state laser. The laser beam 19 passes through the support layer 13 to strike the surface 15 of the cathode 11 at a laser focal spot 21. The laser beam 19 is varied in terms of its shape, intensity and/or time structure by optics 18, so the electron current strength can be correspondingly varied through the injected laser power. The laser beam thereby can also be split into partial laser beams. In this case each of the partial laser beams generates a partial laser focal spot of which the laser focal spot 21 is composed, thus an asymmetrical laser focal spot can be realized in a simple manner and a heating and cooling can be better controlled by this composite laser focal spot.

When (as in this case) the laser focal spot passes through the support layer 13 from outside of the vacuum housing 1 to strike the surface 15 of the cathode 11, the optics 18 that vary (adjust) the laser beam 19 in terms of its properties are arranged outside of the vacuum housing 1. In the event that (as is shown in FIG. 2) the laser beam enters into the inside of the vacuum housing 1 via an optically transparent window 63, the optics 18 can also be located inside the vacuum housing 1.

Electrons arise from the laser focal spot 21 in the form of an electron cloud and are directed onto the anode in an electron beam 23 by the high voltage applied between the cathode 11 and the anode 5. The electron beam 23 strikes the surface 9 of the anode 5 in a spatially stationary focal spot 25. Due to the rotation of the vacuum housing 1, the arising heat is distributed along the focal ring 27 on the surface 9 of the anode 5. The arising heat is conducted to the outside of the vacuum housing 1 via the support layer 7 of the anode 5.

X-ray radiation 29 is emitted from the focal spot 25, the material being transparent for x-ray radiation 29 at the point of the vacuum housing 1 from which the x-ray radiation 29 exists. A magnet system 31 is located outside of the vacuum housing 1, such that the electron beam 23 can be shaped and directed. Alternatively, an electrostatic arrangement (for example capacitors) with which the electron beam can be shaped and directed can be mounted instead of the magnet system 31. A motor 35 that is connected with the vacuum housing 1 via a drive shaft 33 rotates the vacuum housing 1 around its axis 3. The longitudinal axis of the drive shaft 33 coincides with the axis 3 of the vacuum housing 1. Connections to apply a high voltage between the anode 5 and the cathode 11 are located in the drive shaft 33.

FIG. 2 shows a longitudinal section of a further cylindrical design of the vacuum housing 1. The cathode 11 has a surface 15 and a support layer 13 and is located entirely inside the vacuum housing 1. The laser beam 19 strikes the surface 15 of the cathode through an optically transparent window 63 that is located in the opposite base of the vacuum housing 1. So that the optical window does not lose transparency to any degree of severity in the course of the usage of the x-ray radiation, it can be protected by protective plates from clouding (fogging) with material that vaporizes during the operation of the x-ray radiator.

As in the embodiment shown in FIG. 1, the surface 15 of the cathode 11 can be heated by an electrical arrangement 61. The base temperature of the surface 15 of the cathode 11 thereby increases, such that less laser power is required in order to achieve the emission temperature. The surface 15 alternatively can be preheated optically (for example by a further laser beam) or inductively (by further magnetic fields).

The electron beam 23 strikes the surface 9 of the anode 5 that is located on a support layer 7 that transports the heat from the surface of the anode 9 to the outside of the vacuum housing. X-rays are emitted from the surface of the anode 9 through a region 65 of the vacuum housing that is transparent for x-rays. The entire vacuum housing 1 is surrounded by a radiator housing 67 that is filled with a coolant 69, such that an effective cooling of the entire system is ensured.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray radiator comprising:
a cathode that thermionically emits electrons upon irradiation of a surface of the cathode by a laser beam;
an anode;
respective electrical connections to said anode and to said cathode allowing application of a high voltage between said anode and said cathode to accelerate electrons emitted by said cathode toward said anode as an electron beam;
said anode comprising an anode surface facing said cathode that emits x-rays upon being struck by said electron beam; and
said surface of said cathode having at least one surface characteristic selected from the group consisting of a surface roughening, a surface porosity, a surface doping, an intermetallic compound surface composition, and a vitreous carbon surface composition.

2. An x-ray radiator as claimed in claim 1 wherein said surface characteristic is said surface roughening, and wherein said surface of said cathode is sintered.

3. An x-ray radiator as claimed in claim 1 wherein said surface characteristic is a surface doping, and wherein said surface is doped with a doping agent selected from the group consisting of oxides of the rare earths and mischmetals of the rare earths.

4. An x-ray radiator as claimed in claim 3 wherein said doping agent is at least one doping agent selected from the group consisting of La₂O₃, CeO and thorium.

5. An x-ray radiator as claimed in claim 3 wherein said surface of said cathode has a composition and wherein said doping agent comprises a portion of said composition between 0.5% and 20%.

6. An x-ray radiator as claimed in claim 3 wherein said surface characteristic is at least one of said surface roughening and said surface doping, and wherein said surface of said cathode comprises a base material comprising at least one material selected from the group consisting of tungsten, rhenium, molybdenum, thorium, tantalum and intermetallic compounds.

7. An x-ray radiator as claimed in claim 6 wherein said base material is said intermetallic compound in said group of materials, and wherein said intermetallic compound forming said base material exhibits an electron work function in a range selected from the group of ranges consisting of between 2.2 eV and 2.6 eV at 1300K, and between 2.5 eV and 2.7 eV at 2100K.

8. An x-ray radiator as claimed in claim 6 wherein said base material is said intermetallic compound in said group of materials, and wherein said intermetallic compound forming said base material exhibits a mixture in a range selected from the group of ranges consisting of 1:1, 1;2, 1:3, 1:4 and 1:5.

9. An x-ray radiator as claimed in claim 1 wherein said surface characteristic is said vitreous carbon composition, and wherein said vitreous carbon composition exhibits and electron work function in a range between 1.8 eV and 2 eV.

10. An x-ray radiator as claimed in claim 1 wherein said surface characteristic is said vitreous carbon composition, and wherein said vitreous carbon composition exhibits a reflectivity in a range between 10% and 50% in a spectral range between 800 nm and 12 nm.

11. An x-ray radiator as claimed in claim 1 wherein said surface characteristic is said vitreous carbon composition, and wherein said vitreous carbon composition exhibits a density in a range between 900 kg/m³ and 1700 900 kg/m^{3.}

12. An x-ray radiator as claimed in claim 1 wherein said surface characteristic is said vitreous carbon composition, and wherein said vitreous carbon composition exhibits a specific heat capacity in a range selected from the group of ranges consisting of 1 to 1.3 J/(gK) at 200° C., 1.6 to 2/0 J/(gK) at 700° C., and 1.9 to 2.2 J/(gK) at 1400° C.

13. An x-ray radiator as claimed in claim 1 wherein said surface characteristic is said vitreous carbon composition, and wherein said vitreous carbon composition exhibits a heat conductivity in a range selected from the group of ranges consisting of 6.0 to 7.2 W/(mK) at 20° C., 9.3 to 11.5 W/(mK) at 750° C., and 10.0 to 12.5 W/(mK) at 1200° C.

14. An x-ray radiator as claimed in claim 1 wherein said surface characteristic is said intermetallic compound composition, and wherein said intermetallic compound composition comprises a mischmetal of at least one rare earth.

15. An x-ray radiator as claimed in claim 14 wherein said intermetallic compound is IrCe.

16. An x-ray radiator as claimed in claim 1 wherein said surface characteristic is said intermetallic compound composition, and wherein said intermetallic compound composition exhibits an electron work function in a range selected from the group of ranges consisting of between 2.2 eV and 2.6 eV at 1300K, and between 2.5 eV and 2.7 eV at 2100K.

17. An x-ray radiator as claimed in claim 1 wherein said surface characteristic is said intermetallic compound composition, and wherein said intermetallic compound composition exhibits a mixture ratio in a range selected from the group of ranges consisting of 1:1, 1;2, 1:3, 1:4 and 1:5.

18. An x-ray radiator as claimed in claim 1 comprising:
a vacuum housing having an interior in which at least said anode surface and said cathode surface are disposed, said vacuum housing being mounted for rotation around a rotation axis;
said vacuum housing comprising an insulator that separates said cathode from said anode;
a drive rotationally connected to said vacuum housing that rotates said vacuum housing around said rotation axis;
a cooling arrangement that cools at least said anode during emission of said x-rays; and
a stationary source for said laser beam and an arrangement that directs said laser beam from said stationary source onto a stationary laser focal spot on said surface of said cathode, and that focuses said laser beam.

19. An x-ray radiator as claimed in claim 1 comprising a heating arrangement that heats at least said surface of said cathode, said heating arrangement being selected from the group consisting of electrical heating arrangements, optical heating arrangements, and inductive heating arrangements.

20. An x-ray radiator as claimed in claim 1 wherein said cathode comprises a substrate on which said surface of said cathode is disposed,

21. An x-ray radiator as claimed in claim 20 wherein said substrate has a substrate surface, and wherein said surface of said cathode is applied onto said substrate surface.

22. An x-ray radiator as claimed in claim 20 wherein said substrate has a substrate surface forming said surface of said cathode.

23. An x-ray radiator as claimed in claim 21 wherein said cathode is oriented relative to said laser beam to cause said laser beam to pass through said substrate in order to strike said surface of said cathode.

24. An x-ray radiator as claimed in claim 20 wherein said cathode is oriented relative to said laser beam so that said laser focal spot is disposed at a side of said surface of said cathode facing away from said substrate.
